(19) United States
(12) Patent Application Publication
(10) Pub. No.: US 2017/0314873 A1
(43) Pub. Date: Nov. 2, 2017

(54) HEAT CONDUCTION MODULE STRUCTURE AND METHOD OF MANUFACTURING THE SAME

(71) Applicant: TAIWAN MICROLOOPS CORP., New Taipei City (TW)

(72) Inventors: Chun-Hung LIN, New Taipei City (TW); Chang-Yin CHEN, New Taipei City (TW)

(21) Appl. No.: 15/143,537

(22) Filed: Apr. 30, 2016

(51) Int. Cl. F28D 15/04; F28D 15/02; B23P 15/26

(52) U.S. Cl. CPC F28D 15/046; B23P 15/26; F28D 15/0275

(57) ABSTRACT

A heat conduction module structure and a method of manufacturing the same are provided. The structure includes a vapor chamber, a heat pipe, a porous sintered structure, and a working fluid. The vapor chamber includes a lower housing and an upper housing. A cavity is formed between the upper housing and the lower housing. The upper housing includes a through hole and a circular wall. The heat pipe includes a first section and a second section. The first section has a greater inner diameter than that of the second section. The first section includes an opening. The heat pipe is arranged to be perpendicular corresponding to the circular wall and communicates with the through hole by means of the opening. The porous sintered structure is formed from the through hole to the first section. The working fluid is filled in the cavity.

### TECHNICAL FIELD

The present invention relates to a heat conduction technique and, in particular, to a heat conduction module structure and a method of manufacturing the same.

### BACKGROUND

With the development in the computing speed of electronic components, the heat generated from the electronic components also becomes higher and higher. In order to solve the high heat generation problem, the industry extensively utilizes vapor chambers and heat pipes having good heat conduction properties. However, improvement should be made for current vapor chambers and heat pipes for good heat conduction efficiency, low production costs, and ease of production.

In a conventional assembly structure of a vapor chamber and a heat pipe, a heat pipe is normally disposed perpendicularly on the vapor chamber. The heat pipe does not communicate with the vapor chamber, and heat can only be transferred and dissipated away by means of heat conduction. Such a structure cannot achieve uniform temperature distribution for the vapor chamber and the heat pipe, and as a result, the heat conduction efficiency is greatly compromised. In solution, the industry utilizes a through hole formed on the vapor chamber to connect the heat pipe. However, the manufacturing process is troublesome and complicated, and a working fluid inside does not have a good circulation effect, so improvement is required to solve the above-mentioned problems.

### SUMMARY

It is an object of the present invention to provide a heat conduction module structure and a method of manufacturing the same, thereby effectively simplifying a manufacturing process and improving heat conduction and heat dissipation efficiency.

Accordingly, the present invention provides a method of manufacturing a heat conduction module, comprising steps of:

a) preparing a metal board, processing the metal board to form a through hole and a circular wall;

b) preparing a heat pipe, processing the heat pipe to form a first section and a second section, the first section including an opening;

c) arranging the heat pipe to be perpendicular corresponding to the circular wall to allow the opening to communicate with the through hole;

d) inserting a core rod from the through hole to be blocked by the second section;

e) filling a metallic powder into an outer periphery of the core rod from the through hole;

f) performing a sintering process on a half-finished product of step e) to form a porous sintered structure from the through hole to the first section and to form an upper housing;

g) preparing a lower housing, sealing the lower housing with respect to the upper housing; and

h) performing a fluid filling process and a degas sealing process on the half-finished product of step g).

Accordingly, the present invention provides a heat conduction module structure, comprising a vapor chamber, a heat pipe, a porous sintered structure, and a working fluid. The vapor chamber includes a lower housing and an upper housing sealed with respect to the lower housing, a cavity is formed between the upper housing and the lower housing, and the upper housing includes a through hole and a circular wall extending from a circumference of the through hole. The heat pipe includes a first section and a second section extending from the first section, the first section has a greater inner diameter than an inner diameter of the second section, the first section includes an opening, the heat pipe is disposed perpendicularly corresponding to the circular wall and communicates with the through hole by means of the opening. The porous sintered structure is formed from the through hole to the first section. The working fluid is filled in the cavity.

The present invention further includes the following functions. By utilizing the porous sintered structure connected to the first capillary structure and the second capillary structure, a good circulation of the working fluid inside is achieved.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a method flowchart of the present invention;

FIG. 2 is a cross-sectional view showing a metal board of the present invention;

FIG. 3 is a cross-sectional view of the present invention, showing the metal board after formation processing;

FIG. 4 is a cross-sectional view of the present invention, showing a heat pipe after formation processing;

FIG. 5 is a cross-sectional view of the present invention, showing assembly of a metal board, a heat pipe, and a core rod;

FIG. 6 is a cross-sectional view of the present invention, showing a metallic powder filled into a through hole and an inner surface of the metal board;

FIG. 7 is a cross-sectional view of the present invention, showing an upper housing and a lower housing assembled with respect to each other; and

FIG. 8 is a cross-sectional view according to another embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

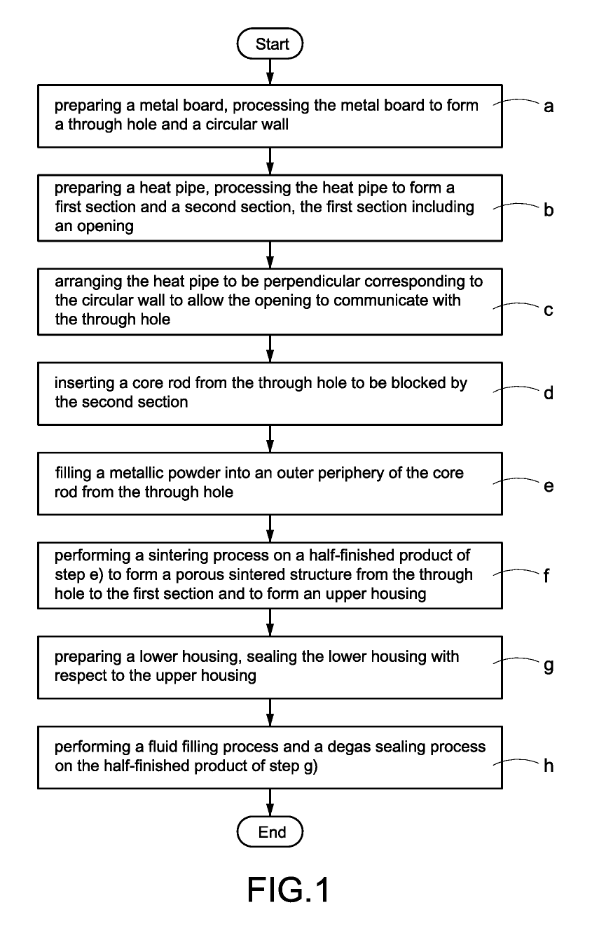

Referring to FIGS. 1 to 7, the present invention provides a method of manufacturing a heat conduction module, comprising steps of:

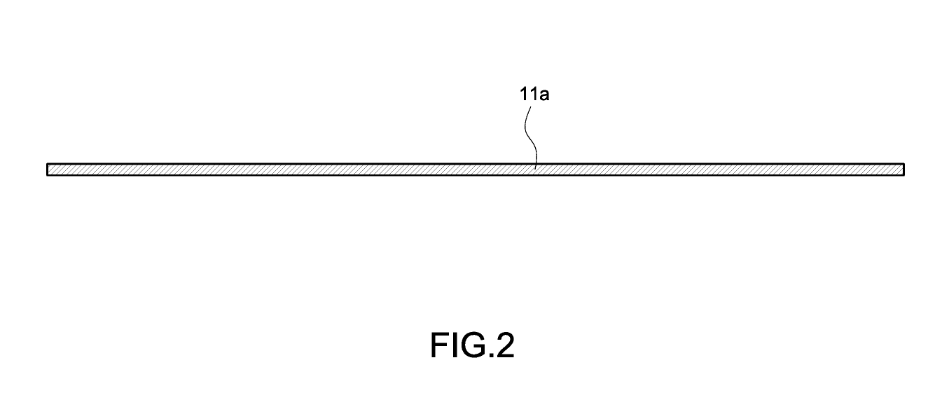

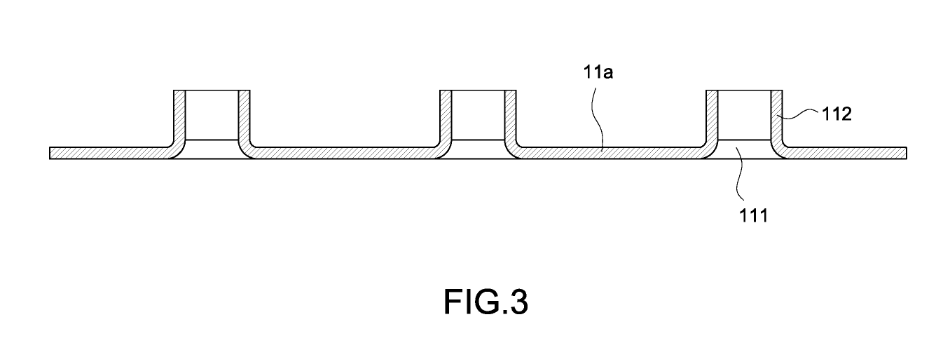

a) Preparing a metal board 11a, processing the metal board 11a to form a through hole 111 and a circular wall 112. Referring to FIGS. 2 and 3, in this step, the metal board 11a can consist of aluminum, copper or alloy thereof. A mold (not illustrated) is utilized to perform a forming-hole and extension process on the metal board 11a, so as to form a plurality of through holes 111 on the metal board 11a and a circular wall 112 extending from a circumference of each of the through holes 111. The number of the through holes 111 can vary as required; a miniaturized heat dissipation device can also include only one through hole 111.

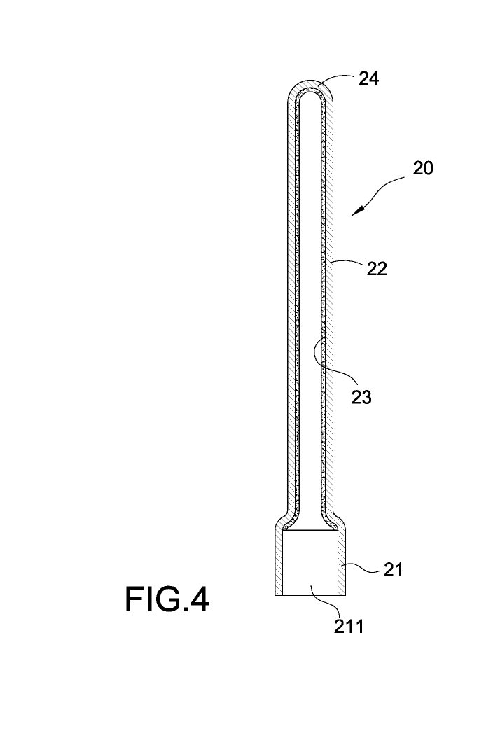

b) Preparing a heat pipe 20, processing the heat pipe 20 to form a first section 21 and a second section 22, the first section 21 including an opening 211. Referring to FIG. 4, step b) can be performed before or after step a). The heat pipe 20 in this step can consist of aluminum, copper or alloy thereof. In this step, the processing method can be a pipe expansion process or a pipe shrinkage process. The pipe expansion process is performed on the first section 21 of the heat pipe 20 to enlarge an inner diameter of the first section 21, so that the inner diameter of the first section 21 is greater than an inner diameter of the second section 22. The pipe shrinkage process is performed on the second section 22 of the heat pipe 20 to reduce the inner diameter of the second section 22, so that the inner diameter of the first section 21 is greater than the inner diameter of the second section 22. A length of the first section 21 ranges from 0.5 to 10 millimeters. The first section includes an opening 211 at its top end. A second capillary structure 23 is disposed inside the heat pipe 20, and the second capillary structure 23 can be a metallic woven web, a porous sintered powder element, or a groove element. A close end 24 is formed at an end portion of the second section 22.

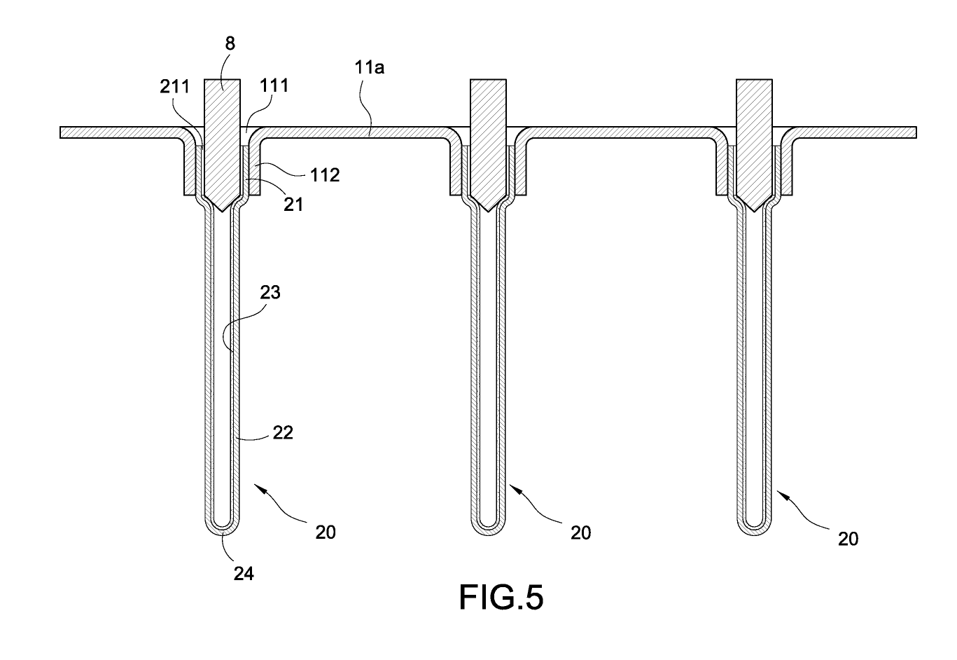

c) Arranging the heat pipe 20 to be perpendicular corresponding to the circular wall 112 to allow the opening 211 to communicate with the through hole 11. Referring to FIG. 5, in this step, an adhesive (e.g. a solder paste, not illustrated) is applied onto an outer circumferential surface of the first section 21 of the heat pipe 20, and then the first section 21 of the heat pipe 20 is inserted with respect to the circular wall 112 for connection, so as to allow the opening 211 to communicate with the through hole 111. In this embodiment, the first section 21 is disposed inside the circular wall 112.

d) Inserting a core rod 8 from the through hole 111 to be blocked by the second section 22. Referring to FIG. 5, in this step, the core rod 8 is inserted into the opening 211 from the through hole 111 and the first section 21 of the heat pipe 20 and is blocked by the second section 22 to be positioned.

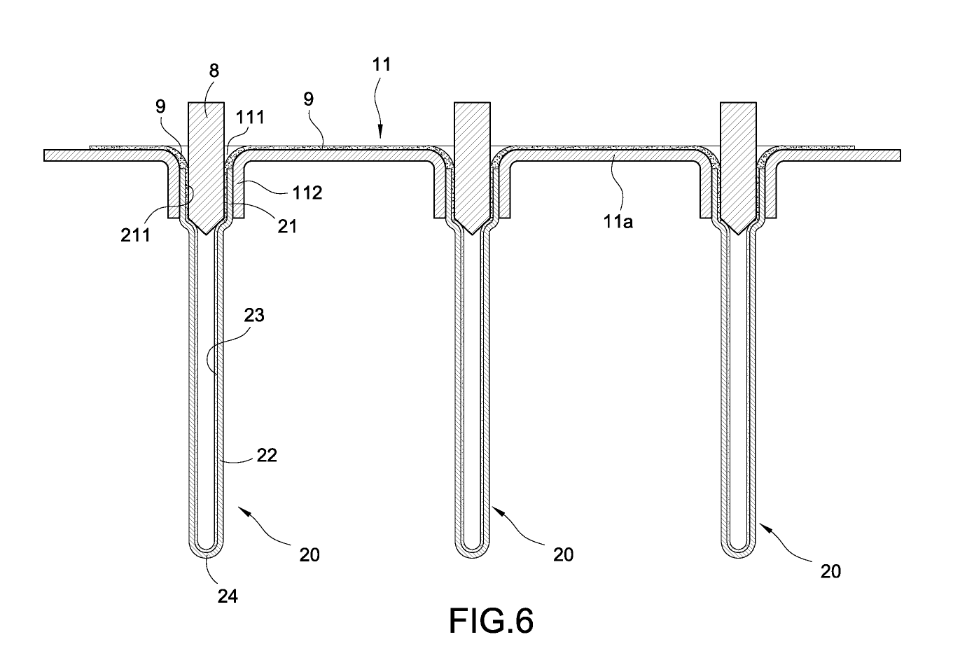

e) Filling a metallic powder 9 into an outer periphery of the core rod 8 from the through hole 111. Referring to FIG. 6, in this step, the metallic powder 9 is filled from the through hole 111 into the outer periphery of the core rod 8 between the core rod 8 and an inner surface of the first section 21. At the same time, the metallic powder 9 can be sprayed on an inner surface of the metal board 10 to form a first capillary structure 13. The first capillary structure 13 is a porous sintered powder element.

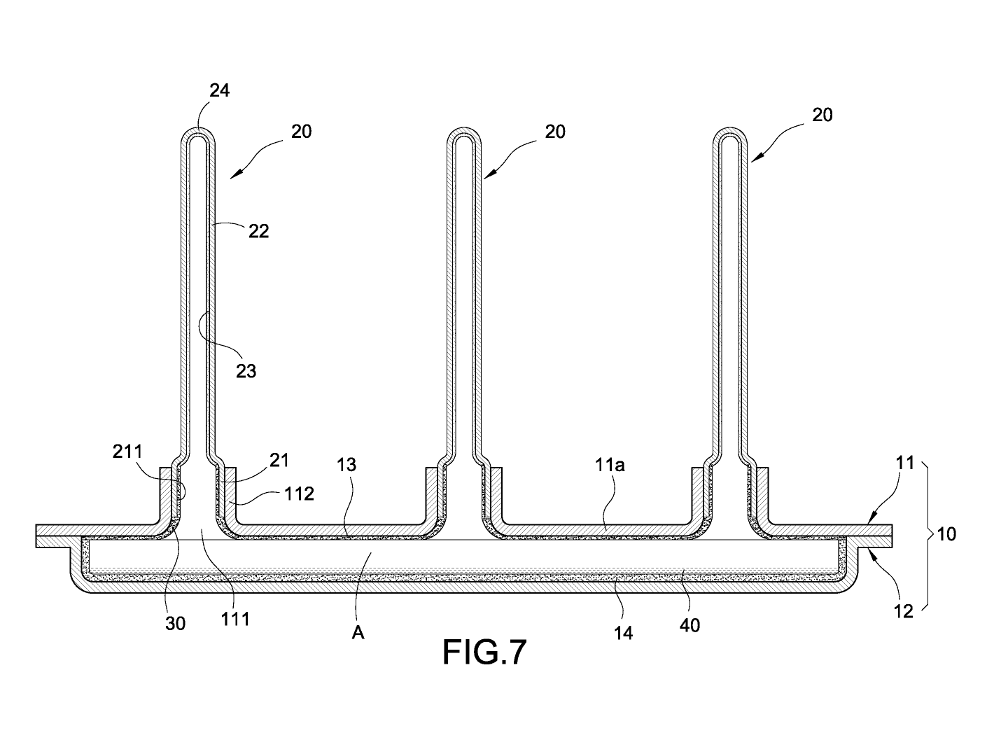

f) Performing a sintering process on a half-finished product of step e) to form a porous sintered structure 30 from the through hole 111 to the first section 21 and to form an upper housing 11. Referring to FIG. 6, in this step, the half-finished product having the metallic powder 9 filled therein and having the metallic powder 9 sprayed thereon is sent into a heating apparatus (not illustrated) to perform the sintering process. After completion of the sintering process, the core rod 8 is removed, so the porous sintered structure 30 (as shown in FIG. 7) is formed from around the through hole 111 to the inside of the first section 21, and an upper housing 11 is formed. The porous sintered structure 30 produced from completing this step is connected to the first capillary structure 13 and the second capillary structure 23.

g) Preparing a lower housing 12, sealing the lower housing 12 and the upper housing 11 with respect to each other. Referring to FIG. 7, in this step, the lower housing 12 has been processed in advance to form a cavity and a third capillary structure 14 in the cavity. The third capillary structure 14 can be a metallic woven web, a porous sintered powder element, a groove element, or etc. The lower housing 12 and the upper housing 11 are sealed with respect to each other by welding to form a cavity A between the upper housing 11 and the lower housing 12.

h) Performing a fluid filling process and a degas sealing process on the half-finished product of the step g). Referring to FIG. 7, in this step, a working fluid such as water or other fluid is filled into the cavity A via a fluid feeding degas pipe (not illustrated), and a degas process, a sealing process and other processes are performed to complete production.

Referring to FIG. 7, the present invention provides a heat conduction module structure, comprising a vapor chamber 10, a heat pipe 20, a porous sintered structure 30, and a working fluid 40. The vapor chamber 10 includes a lower housing 12 and an upper housing 11 sealed with respect to the lower housing 12. A cavity A is formed between the upper housing 11 and the lower housing 12. A first capillary structure 13 is disposed inside the cavity A. The upper housing 11 includes a through hole 111 and a circular wall 112 extending from a circumference of the through hole 111. The heat pipe 20 includes a first section 21 and a second section 22. An inner diameter of the first section 21 is greater than an inner diameter of the second section 22. The first section 21 includes an opening 211, and a second capillary structure 23 is disposed inside the first section 211. The heat pipe 20 is disposed perpendicularly corresponding to the circular wall 112 and communicates with the through hole 111 by means of the opening 211. The porous sintered structure 30 is formed from the through hole 111 to the first section 21 and is connected to the first capillary structure 13 and the second capillary structure 23. The working fluid 40 is filled into the cavity A.

When in use, the working fluid 40 in a liquid state is heated to be vaporized to be converted into a gaseous state, the working fluid 40 in the gaseous state carrying a large amount of heat flows to the opening 211 of each heat pipe 20 and reaches the close end 22 of the heat pipe 20. After the working fluid 40 in the gaseous state dissipates heat by means of the heat pipes 20 in thermal contact with a plurality of heat dissipation plates (not illustrated), the working fluid 40 is condensed into the liquid state and flows back to the cavity A via the second capillary structure 23, the porous sintered structure 30 and the first capillary structure 13 sequentially. The first capillary structure 13 and second capillary structure 23 are connected via the porous sintered structure 30 to form a continuous reverse-flow path, thereby increasing a reverse-flow speed of the fluid.

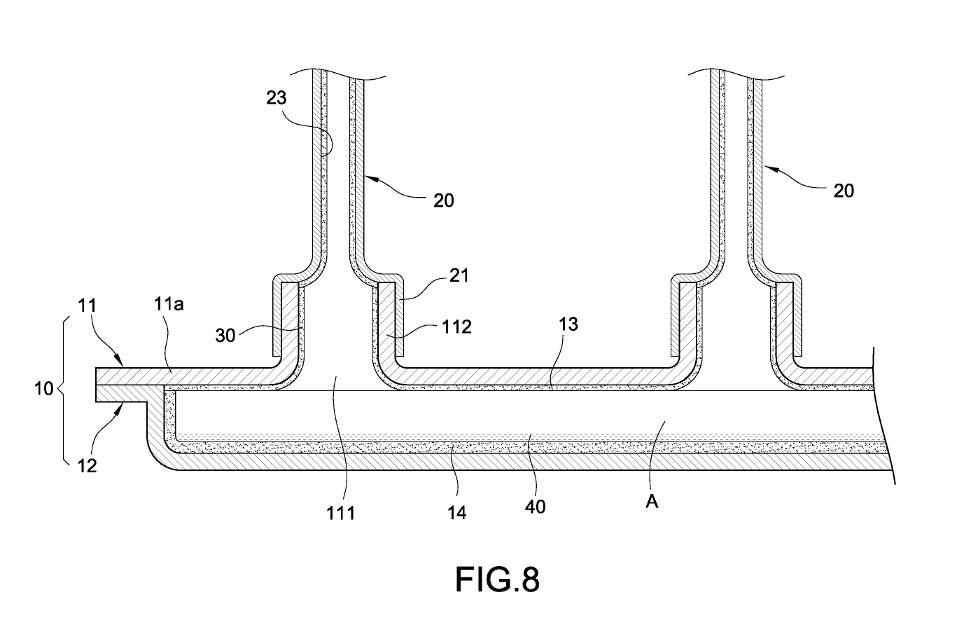

Referring to FIG. 8 concerning the heat conduction module of the present invention, in addition to the above-mentioned embodiment, an adhesive can be applied to an outer circumferential surface of the circular wall 112, then the first section 21 of the heat pipe 20 encloses the circular wall 112 to be connected and to allow the opening 211 to communicate with the through hole 111. In the embodiment, the circular wall 112 is accommodated inside the first section 21.

In summary, the heat conduction module structure and the method of manufacturing the same according to the present invention certainly can achieve the anticipated objectives and solve the defects of conventional techniques, and have novelty and non-obviousness. Therefore, a request to patent the present invention is filed according to patent law. Examination is kindly requested, and allowance of the present application is solicited to protect the rights of the inventor.

What is claimed is:

1. A method of manufacturing a heat conduction module, comprising steps of:
a) preparing a metal board, processing the metal board to form a through hole and a circular wall;
b) preparing a heat pipe, processing the heat pipe to form a first section and a second section, the first section including an opening;
c) arranging the heat pipe to be perpendicular corresponding to the circular wall to allow the opening to communicate with the through hole;
d) inserting a core rod from the through hole to be blocked by the second section;
e) filling a metallic powder into an outer periphery of the core rod from the through hole;
f) performing a sintering process on a half-finished product of step e) to form a porous sintered structure from the through hole to the first section and to form an upper housing;
g) preparing a lower housing, sealing the lower housing with respect to the upper housing; and
h) performing a fluid filling process and a degas sealing process on the half-finished product of step g).

2. The method of manufacturing the heat conduction module of claim 1, wherein step b) is performed before step a).

3. The method of manufacturing the heat conduction module of claim 1, wherein the processing in step b) is performing a pipe expansion process on the first section.

4. The method of manufacturing the heat conduction module of claim 1, wherein the processing in step b) is performing a pipe shrinkage process on the second section.

5. The method of manufacturing the heat conduction module of claim 1, wherein in step c), the first section is inserted through the circular wall to be accommodated inside the circular wall.

6. The method of manufacturing the heat conduction module of claim 5, wherein the upper housing includes a first capillary structure, the heat pipe includes a second capillary structure, and the porous sintered structure in step f) is formed on an inner surface of the first section and connected to the first capillary structure and the second capillary structure.

7. The method of manufacturing the heat conduction module of claim 6, wherein the first capillary structure is a porous sintered powder element, and the porous sintered powder element is integrally formed with the porous sintered structure.

8. The method of manufacturing the heat conduction module of claim 1, wherein in step c), the first section encloses the circular wall to accommodate the circular wall inside the first section.

9. The method of manufacturing the heat conduction module of claim 8, wherein the upper housing includes a first capillary structure, the heat pipe includes a second capillary structure, and the porous sintered structure in step f) is formed at an inner surface of the circular wall and is connected to the first capillary structure and the second capillary structure.

10. The method of manufacturing the heat conduction module of claim 9, wherein the first capillary structure is a porous sintered powder element, and the porous sintered powder element is integrally formed with the porous sintered structure.

11. A heat conduction module structure, comprising:
a vapor chamber, the vapor chamber including a lower housing and an upper housing sealed with respect to the lower housing, a cavity is formed between the upper housing and the lower housing, the upper housing including a through hole and a circular wall extending from a circumference of the through hole;
a heat pipe, the heat pipe including a first section and a second section extending from the first section, the first section having a greater inner diameter than an inner diameter of the second section, the first section including an opening, the heat pipe being disposed perpendicularly corresponding to the circular wall and communicating with the through hole by means of the opening;
a porous sintered structure formed from the through hole to the first section; and
a working fluid filled in the cavity.

12. The heat conduction module structure of claim 11, wherein a first capillary structure is disposed inside the cavity, a second capillary structure is disposed inside the heat pipe, and the porous sintered structure is connected to the first capillary structure and the second capillary structure.

13. The heat conduction module structure of claim 12, wherein the first section is inserted through the circular wall to be accommodated inside the circular wall.

14. The heat conduction module structure of claim 13, wherein the porous sintered structure is formed at an inner surface of the first section.

15. The heat conduction module structure of claim 12, wherein the first section encloses the circular wall to accommodate the circular wall inside the first section.

16. The heat conduction module structure of claim 15, wherein the porous sintered structure is formed at an inner surface of the circular wall.
